(19) United States
(12) Patent Application Publication
(10) Pub. No.: US 2011/0319060 A1
(43) Pub. Date: Dec. 29, 2011

(54) Method and System for Obtaining Mobile Metrics

(76) Inventor: Gerald Gentemann, Montgomery, AL (US)

(21) Appl. No.: 13/171,224

(22) Filed: Jun. 28, 2011

Related U.S. Application Data
(60) Provisional application No. 61/358,984, filed on Jun. 28, 2010.

(51) Int. Cl. H04W 24/00

(52) U.S. Cl. 455/414.1

(57) ABSTRACT

Described herein are embodiments of systems, methods and computer program products for measuring data usage, numbers of videos streamed to mobile devices or content shared to mobile, that is useful for obtaining mobile metrics of usage and content. The mobile metrics are rich in content and readily useable such that information can be displayed, organized and/or analyzed in a manner that is easily understandable and subject to comparison.

### CROSS-REFERENCE TO RELATED APPLICATIONS

This patent application claims priority to U.S. Provisional Patent Application Ser. No. 61/358,984 entitled “METHOD AND SYSTEM FOR OBTAINING MOBILE METRICS,” and filed on Jun. 28, 2010. The entirety of the above-captioned patent application is incorporated herein by reference.

### BACKGROUND

Sir Martin Sorrell the founder of WPP Group, a world leader in marketing communications, recently referred to the mobile phone as, “The most efficient direct response machine ever invented.”

No device is as personal and certainly no device is as valuable for consumers wishing to gather information in the context of their daily lives. This affinity for technology translates into new and different expectations about how to gather, work with, translate, and share information. The implication of this change is profound: a brand's target market expects to be able to gather and share information in multiple devices in multiple places.

The use of wireless connections (e.g., Bluetooth, 802.11x, etc.) is growing and storage devices such as secure digital (SD) cards, mini-SD cards, flash drives, etc. are small enough to be portable. This uprooting of media and communication from fixed places leads to major changes in the way people access information and communicate with each other. Portable storage and wireless connections allow people to shift the way they spend their time with media and the places in which they consume media and information.

Data, voice and video carriers (e.g., Verizon, AT&T, etc.) are continuously looking for technology that allows consumers easier access to the media and information. Two of the most recent technologies that will dynamically change consumer mobile behavior include StarStar® Codes and 2D data matrix codes. Both of these codes make the mobile consumer's link to brands and services even more efficient and thus more personal. By simply dialing an abbreviated dialing code like “**Pizza” or scanning a 2D Code on packaging mobile subscribers “opt in” to receive access to content which can include rich, multi-media interactions delivered immediately to their phone (via, for example, Mobile Web, MMS, or Voice) and designed specifically for them by their favorite brands. Consumers can download apps, wallpapers, ring-tones and digital rewards.

In the carrier networks, no hardware or software is required. The carrier simply enables “**Brand” as a dialing sequence or activates a 2D code. No texting is required. Mobile users do not have to subscribe to the mobile web to receive a brand's message. The system is also handset agnostic. In essence this so-called “mobile gateway” technology makes any handset “smarter.” StarStar® abbreviated dialing codes have been launched on many of the major carrier networks and will soon be available on most, if not all carriers. 2D code readers are available on many handsets already.

This mobile gateway technology will result in an explosion of data for mobile metrics. Although this technology will generate a more granular and deeper set of metrics and key performance indicators (KPIs), there exists no tool or mechanism for brand teams to use to effectively assimilate and analyze this data. Even now, without the advent of new richer data, gathering mobile metrics is difficult. Very often, executives in the mobile industry will say that the marketing potential of mobile reminds them of the early Internet days. Because of this similarity with the web, some of these executives break out boilerplate Internet metrics to measure marketing success in the mobile space using tools such as page views, unique visitors, time spent on a site, cost-per-thousand impressions, registered users, and even click-through of banner ads. However, mobile is not the next Internet. Mobile has its own characteristics separate from those of traditional Internet, with new usage behavior, new business opportunities and new marketing potential. These new mobile gateway codes make the devices even more personal than the Internet. To measure progress of mobile campaigns, mobile-specific measurement tools need to be applied. Standard Internet metrics do not accurately apply to the mobile environment.

Therefore, what are needed are systems and methods that overcome challenges in the art, some of which are described above, that facilitate obtaining metrics of mobile usage.

### SUMMARY

A desktop-like browser on a mobile device essentially treats the mobile device like a magnifying glass for the Internet. However, users don't want a tiny view of a huge web page, they want a mobile-specific experience. The best mobile experiences are more contextual to the phone itself, and embrace the easier points of entry that mobile gateway code technology such as StarStar® and 2D codes provide, the smoother integration of a small page layout, SMS, GPS, and easily installed applications. Measuring page hits and stickiness of Web sites are really not useful mobile metrics.

Therefore, described herein are embodiments of systems, methods and computer program products for measuring data usage, numbers of videos streamed to mobile devices or content shared to mobile, that is useful for obtaining mobile metrics of usage and content.

In one embodiment, a system for obtaining mobile metrics comprises: a server for receiving at least one of a user-specific information and a mobile web data, wherein the at least one of the user specific information and the mobile web data relates to at least one of a mobile device and a user associated with the mobile device; and at least one processor, coupled to the server, configured for, generating a user profile based upon the at least one of the user-specific information and the mobile web data; and analyzing the user profile to determine mobile metrics relating to the at least one of the mobile device and the user.

Also described herein are methods for obtaining mobile metrics. One method comprises: obtaining at least one of a user-specific information and a mobile web data, wherein the at least one of the user specific information and the mobile web data relates to at least one of a mobile device and a user associated with the mobile device; generating a user profile based upon the at least one of the user-specific information and the mobile web data; and analyzing the user profile to determine mobile metrics relating to the at least one of the mobile device and the user.

Another method comprises: accessing a vendor information using a mobile device; obtaining a user-specific information for a user associated with the mobile device; obtaining a mobile web data associated with at least one of the mobile device and the user associated with the mobile device; generating a user profile based upon at least one of the user-specific information and the mobile web data; and analyzing the user profile to determine mobile metrics relating to the at least one of the mobile device and the user.

Further described herein are embodiments of a system and method where a user accesses one or more product or service vendors using a mobile device (e.g., “**pizza”, “**taxi”, etc. or by using 2D tags). User-specific information is obtained about the user associated with the mobile device. For instance, this information can include the products or services accessed using the mobile device, the telephone number of the mobile device, the manufacturer and model of the mobile device, the name, age, gender, address, geographic location and time that the user accessed the products or services, the IP address (if any) associated with the mobile device, etc. For instance, this information can be obtained in an XML format from a marketing system server connected to the telephone system such as the Zoove® server that monitors and provides StarStar® access.

The information obtained from the marketing system server can be used to obtain additional information about the mobile device and the user of the mobile device. For instance, once the IP address of the associated mobile device is obtained from the marketing system server, additional databases can be queried using the IP address to obtain additional information about the Internet activity and mobile web data of the user of the mobile device. Such databases include, for example, social networking access, search engines queries, etc. This additional information can be linked with the user-specific information obtained from the marketing system server to provide extensive demographic and geographic information for a user associated with a particular mobile device. This information can be further analyzed using marketing analysis tools such as, for example, ThinkMap® visualization software (ThinkMap, Inc., New York, N.Y.).

Additional advantages will be set forth in part in the description which follows or may be learned by practice. The advantages will be realized and attained by means of the elements and combinations particularly pointed out in the appended claims or inventive concepts. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a block diagram of an embodiment of a system that can be used to practice aspects according to the present invention;

FIG. 2 is an exemplary flowchart illustrating a method of obtaining and using mobile metrics information that can be implemented using the embodiment of a system as shown in FIG. 1; and

FIG. 3 is a block diagram illustrating an exemplary operating environment for performing the disclosed methods.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### System Overview

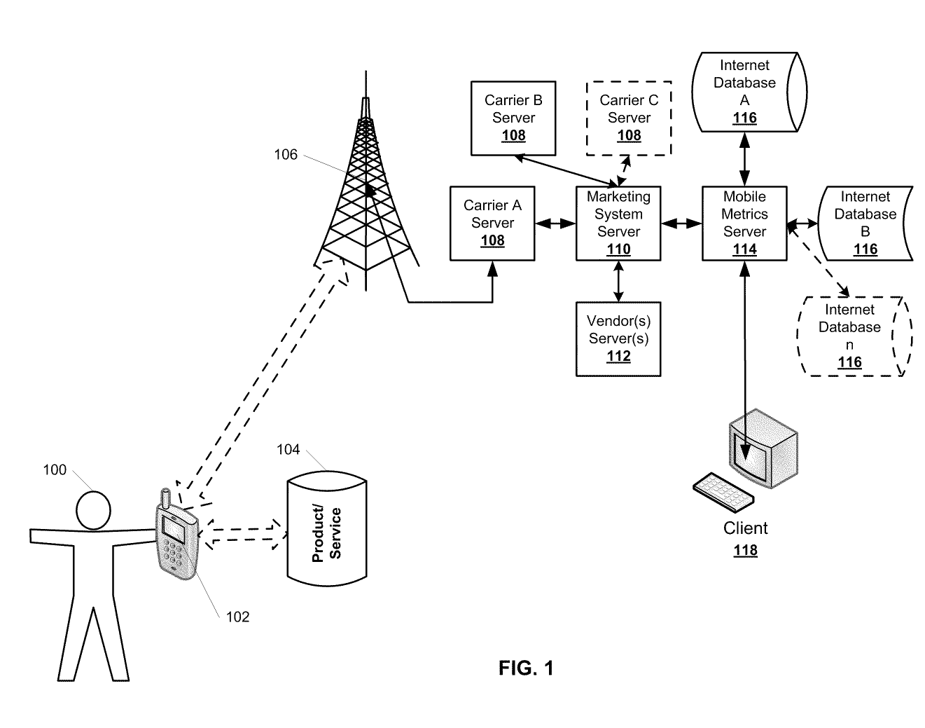

FIG. 1 illustrates a block diagram of an embodiment of a system that can be used to practice aspects according to the present invention. A user 100 associated with a mobile device 102 seeks to obtain additional information about a product 104 or service. The user 100 can utilize various mechanisms to obtain this information including the StarStar® service as provided by Zoove® (Zoove Corp., Palo Alto, Calif.), the 2D or QR bar code management systems such as that provided by ScanLife® (ScanBuy, Inc., New York, N.Y.), or other similar systems as are currently existing or may be developed. For example, using the StarStar® service, the user 100 can enter “**coke” using the alphanumeric keypad of the mobile device 102 if the product 104 they desire information about happened to be a Coca-Cola Company product. Alternatively, the user can scan or image a 2D barcode associated with the product 104 using the mobile device 102. In each instance, specific identifying information about the product 104 or service is transmitted via the mobile device 102 wirelessly to the telephone carrier's system 106 where it is received by a carrier server 108 associated with the wireless carrier. The identifying information is then transmitted to a marketing system server 110. The carrier server 108 may also transmit additional information to the marketing system server 110 including, for example, the telephone number of the mobile device 102, the name and address of the owner or holder of the mobile device 102, geographic information about the location of the mobile device 102 when the identifying information was transmitted, the time the identifying information was sent, an IP address associated with the mobile device 102, etc. As shown in FIG. 1, the marketing system server 110 can be connected to multiple carrier servers 108. For example, one carrier server 108 could be for AT&T, another for Verizon, another for Sprint, etc. In one example, the market system server 110 can be a server under the control of an entity such as Zoove® or ScanLife®. The marketing system server 110 is further connected to vendors' servers 112 so that vendor information associated with identifying information about the product 104 can be obtained and transmitted via the carrier system 106 back to the mobile device 102.

Further comprising the exemplary system of FIG. 1 is a mobile metrics server 114 executing mobile metrics software that receives information from the marketing system server 110 related to the activities of users of the StarStar® service or the 2D code service. This information includes the telephone numbers of mobile devices 102 that have accessed product/service information using the StarStar® service or the 2D code service, the products or services accessed using the StarStar® service or the 2D code service, the name and address of the owners or holders of the mobile devices 102, geographic information about the location of the mobile devices 102 when the identifying information was transmitted, the time the identifying information was sent, IP addresses associated with the mobile devices 102, etc.

Furthermore, the mobile metrics server 114 executing mobile metrics software uses the information obtained from the marketing system server 110 to collect additional information about the user 100 of the mobile device 102 and/or the IP address of the mobile device 102. For example, various Internet databases 116 can be accessed using the telephone number of the mobile device 102, the IP address of the mobile device 102, the name of the owner/holder of the mobile device 102, etc. to further determine additional demographic and geographic information about the user 100. These Internet databases 116 can include, for example, social networking databases, Omniture, Neilsen, Google Analytics, Comscore, etc. However, it is to be appreciated that there are countless Internet databases containing random information about various users. The embodiments described herein mine the additional data generated as the result of activity on mobile devices and present it in readily usable form. The additional demographic and geographic information can be linked by the mobile metrics software with the information obtained from the marketing system server 110 to develop a more complete profile of the user 100 that can include, for example, shopping, buying, browsing, interest, hobby, employment, etc. information about the user 100. This user profile information can be stored in one or more databases associated with the mobile metrics server 114 by mobile metrics software executing on the mobile metrics server as user profile data.

Also shown in FIG. 1 is a client or remote computing device 118 configured to access the profile information stored in a database associated with the mobile metrics server 114. In one aspect, this information can be used for marketing purposes including, for example, determining the effectiveness of marketing campaigns, determining demographics for service or product offerings, determining consumer profiles, etc. In one aspect, the client may utilize software such as, for example, ThinkMap® visualization software (ThinkMap, Inc., New York, N.Y.) to analyze the profile information. Such software may be executing on either the mobile metrics server 114 or the client 118.

It is to be appreciated that the servers 108, 110, 112, 114 and client 118 as shown in FIG. 1 can be comprised of one or a plurality of servers or computers and can be physically located in one or multiple locations and can be connected via various networking means as are known to one of ordinary skill in the art.

### Methods

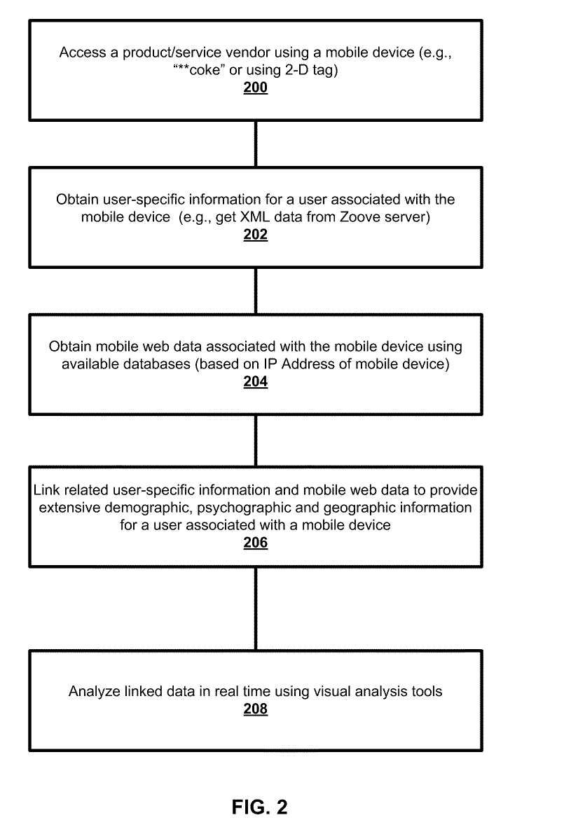

FIG. 2 is an exemplary flowchart illustrating a method of obtaining and using mobile metrics information that can be implemented using the embodiment of a system as shown in FIG. 1. At step 200, a user accesses a product or service vendor using a mobile device. For example, the user may see a sign or label associated with a product or service that indicates the user can obtain additional information, coupons, discounts, etc. about the product or service by dialing, for example, “**pizza” using the mobile device or by scanning or imaging a 2D barcode associated with the product or service. In another aspect, the access can comprise purchasing a product or service using a “mobile wallet” through which an electronic chip in the mobile device allows the user to make a purchase directly through the mobile device in the manner of a credit card. In other aspects, the access mode can comprise access directly to the web via a voice activated mechanism instead of an access code. Yet another aspect of access can comprise “affinity” marketing sites and/or the provision of state sanctioned identification codes and pictures via mobile device. Regardless of the access mode employed, because the information is sent to the telephone carrier associated with the mobile device, the user, owner or holder of the carrier device is a subscriber to the carrier. Therefore, information about the user, owner or holder can be obtained from the records of the carrier as determined by the phone number of the mobile device that has transmitted the StarStar® or 2D information to the carrier. Additional information can be determined at the time the StarStar® or 2D information request is made, including, for example, the time of the request, the product or service for which additional information is sought, the location of the user at the time of the request (as determined by, for example, triangulation or GPS information), device type, etc. Therefore, at step 202, user-specific information can be obtained for a user associated with the mobile device. For example, XML data can be obtained from the marketing system server (e.g., Zoove® server) described above that includes information about the user from the carrier's subscription records and information captured at the time the request is made by the user. This information can be obtained for multiple users over a period of time. In one aspect, this information can include an IP address for the mobile device that made the request.

At step 204, mobile web data associated with the mobile device is obtained. Generally, this data will be obtained using the IP address of the mobile device, but other methods are contemplated including using, for example, the telephone number of the mobile device, the name and/or address of the user, holder or owner of the mobile device, etc. This data may include current and/or prior use of mobile gateway technology codes such as StarStar® or 2D information by the mobile device or the user, holder or owner of the mobile device. This data may be obtained from databases such as, for example, the Zoove® database, social networking databases Omniture, Neilsen, Google Analytics, Comscore, etc.

At step 206, the mobile web data is linked with the user-specific information to provide a profile of the user, which includes extensive demographic, psychographic and geographic information for a user associated with the mobile device. Psychographic data relates to values, attitudes, interests, and lifestyles of a user or group of users. At step 208, this profile information for one or a plurality of users can be used for analysis. For example, the information can be used for marketing analysis. In one aspect, software such as, for example, ThinkMap® visualization software (ThinkMap, Inc., New York, N.Y.) can be used to analyze the profile information of one or a plurality of users. In one aspect, at least a portion of the profile information for one or a plurality of users, or information derived from the profile information such as charts, graphs, tables, comparisons, etc., can be graphically displayed for analysis purposes. Information, including user-specific information and mobile web data can be obtained, updated, linked and/or organized, and displayed in real time (i.e., virtually as soon as it is created).

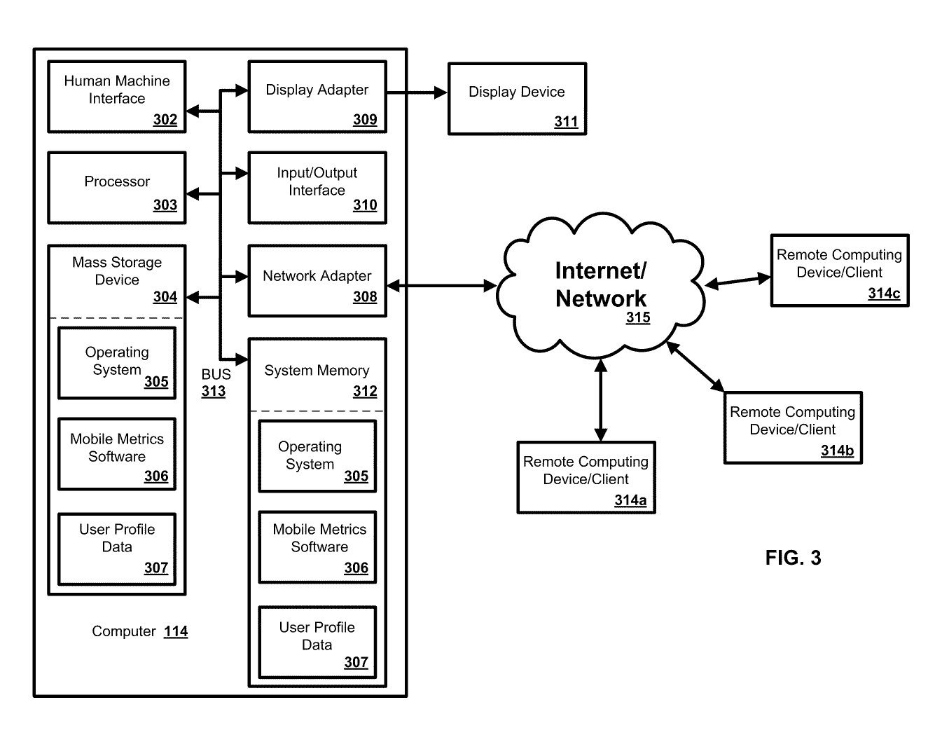

The system has been described above as comprised of units. One skilled in the art will appreciate that this is a functional description and that the respective functions can be performed by software, hardware, or a combination of software and hardware. A unit can be software, hardware, or a combination of software and hardware. The units can comprise the Mobile Metrics Software 306 as illustrated in FIG. 3 and described below. In one exemplary aspect, the units can comprise a computer 114 as illustrated in FIG. 3 and described below.

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 114. The components of the computer 114 can comprise, but are not limited to, one or more processors or processing units 303, a system memory 312, and a system bus 313 that couples various system components including the processor 303 to the system memory 312. In the case of multiple processing units 303, the system can utilize parallel computing.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 313, and all buses specified in this description can also be implemented over a wired or wireless network connection and each of the subsystems, including the processor 303, a mass storage device 304, an operating system 305, mobile metrics software 306, user profile data 307, a network adapter 308, system memory 312, an Input/Output Interface 310, a display adapter 309, a display device 311, and a human machine interface 302, can be contained within one or more remote computing devices or clients 314a,b,c at physically separate locations, connected through buses of this form, in effect implementing a fully distributed system.

The computer 114 typically comprises a variety of computer readable media. Exemplary readable media can be any available media that is accessible by the computer 114 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as user profile data 307 and/or program modules such as operating system 305 and mobile metrics software 306 that are immediately accessible to and/or are presently operated on by the processing unit 303.

In another aspect, the computer 114 can also comprise other removable/non-removable, volatile/non-volatile computer storage media. By way of example, FIG. 3 illustrates a mass storage device 304 which can provide non-volatile storage of computer code, computer readable instructions, data structures, program modules, and other data for the computer 114. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and mobile metrics software 306. Each of the operating system 305 and mobile metrics software 306 (or some combination thereof) can comprise elements of the programming and the mobile metrics software 306. User profile data 307 can also be stored on the mass storage device 304. User profile data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 114 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 114 can have more than one display adapter 309 and the computer 114 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 114 via Input/Output Interface 310. Any step and/or result of the methods can be output in any form to an output device. Such output can be any form of visual representation, including, but not limited to, textual, graphical, animation, audio, tactile, and the like.

The computer 114 can operate in a networked environment using logical connections to one or more remote computing devices 314a,b,c. By way of example, a remote computing device can be a personal computer, portable computer, a server, a router, a network computer, a peer device, a smart mobile device or other common network node, and so on. Logical connections between the computer 114 and a remote computing device 314a,b,c can be made via a local area network (LAN) and a general wide area network (WAN). Such network connections can be through a network adapter 308. A network adapter 308 can be implemented in both wired and wireless environments. Such networking environments are conventional and commonplace in offices, enterprise-wide computer networks, intranets, and the Internet 315.

For purposes of illustration, application programs and other executable program components such as the operating system 305 are illustrated herein as discrete blocks, although it is recognized that such programs and components reside at various times in different storage components of the computing device 114, and are executed by the data processor(s) of the computer. An implementation of mobile metrics software 306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

A search in the mobile context is not as simple as building a clean search site with the most relevant search results. The search issue in mobile revolves around a simplified user experience. This means less text entry and less scrolling than the desktop experience. A more compelling mobile search experience will come from many forms of content discovery—social networks engagement, location-based-service applications and simply sending and receiving links via SMS or email. Fundamentally finding, learning, and discovering content will involve much more than an extremely tiny mobile browser. Discovery of content will be custom-tailored to the mobile user's device functionality, interface, applications and preferences.

Discovery of content could come from a friend's message. from an application, an email, an RSS feed or from a Twitter micro blog. Traditional portals' searches will still come in handy on mobile, certainly, but not as the primary behavior of the mobile user. A better approach to measuring mobile search hits is to tally the activity engaged in mobile data applications, not just the number of times a search button is clicked, which can be accomplished using the mobile metrics software described herein.

Standalone search marketing in mobile is not a viable way to measure search engagement in mobile. Marketers will need to find new ways to calculate how their brands are being discovered and shared in the context of mobile discovery as well. Mobile users want to interact, search and download valuable and targeted content from the Internet, but not in the context of a desktop experience.

The best mobile experiences will come from developers that create a simple, clean, Internet-rich, mobile-specific experience without trying to cram the desktop into a mobile phone. Recently, the Internet has become rich with video. Web video has grown in popularity due to improved CDN technologies and broadband penetration. There are approximately 15 billion videos on the Internet today. Video can quickly and easily be translated to mobile with powerful backend transcoding and streaming tools. In the context of mobile, a powerful experience leverages the native tools of the device such as the device media player. Both StarStar® and 2D codes enable the native tools in a handset thus capturing the data derived from video usage. Mobile devices are increasingly more media-friendly and data networks are always improving, thus the use of mobile devices for even greater web engagement is expected to increase. Even with spotty network coverage. 2G and 3G data networks and a fragmented device market, video can easily be streamed to the majority of mobile users. Seventy-five percent of U.S. users can view mobile video, according to a recent study. When measuring mobile web engagement, it is better to measure user impressions as videos streamed rather than HTML pages viewed by employing embodiments described herein of mobile metrics software. Mobile video could become more relevant than static web pages, given that mobile web browsing is clunky and mobile video streaming of rich web video is much more appropriate in a mobile environment.

### Beyond Advertising

As mobile executives hype up the potential of mobile, they often envision growing advertising revenue to challenge Google's massive advertising revenue. But savvy businesses such as MySpace have recognized that they cannot simply hope to take a share of advertising dollars—they should seek other revenue models as well. Certainly serving advertising may be part of the revenue model. Embodiments of mobile metrics software described herein is a tool that can help brands manage content and advertising messaging.

The new carrier technology (e.g., StarStar® and 2D) will affect brand impressions and conversion. Mobile is not just another platform for e-commerce. Mobile, at least for now, has been less about conversions or payments, and more about brand impressions and brand awareness.

The big bathers to e-commerce adoption on the Internet were trust and instant gratification. With destination sites such as Amazon and eBay, users learned to search through millions of items to find what they want (selection) and click to buy (convenience). The current e-commerce model won't directly apply to mobile. Again, the best experiences will cater specifically to the mobile experience. For example, a user could stream a mobile video from a social network to their phone and then click to buy the song from that video. Buying digital media such as ringtones and wallpaper may make sense in the mobile context. So, instead of measuring purchases made from mobile, a combination of brand impressions, videos streamed and digital purchases can be more appropriately measured by embodiments of the mobile metrics software described herein. Further, embodiments described herein can measure mobile-specific impressions such as amount of data downloaded, number of video impressions and purchase intent after viewing a branded video, for example, and provide access to “real time” data that will include age, gender and geographic targeting by zip code with the unique ability to interact with individual consumers.

### Summary

The carriers' new StarStar® and 2D codes will eliminate the need for complex algorithms and guess work for determining user profile information while adding even richer data. The data then can be analyzed in a deeper more granular manner as traditional web-analytics tools lack mobile-specific metrics and web tools often lack the full carrier and device information. The new technologies from the carriers recognize each individual device.

Tracking users in mobile is challenging. Embodiments described herein accurately track users across the broadest range of carrier and device combinations using data from the carriers including carrier identification; user location information; internal search information (embodiments described herein of the mobile metrics software tracks the query terms of internal website searches); A vs. B Testing (embodiments described herein use tracking IDs to allow publishers to track actions, events, and conditions independent of page-views. Tracking IDs are a great way to perform A vs B testing.); and funnel analysis (provides insights into user-behavior and page navigation and can he identify drop-off points in flows.)

Furthermore, strategy teams often need search functions to find consumer groups and demographics, etc. within the stored profile information. In one aspect, embodiments described herein provide functionality that allows such searches to be performed and can in some instances provide an additional feature that allows teams to search outside of the stored profile information. For example, this search functionality can link to external search engines such as, for example Google search, if desired

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims or inventive concepts.

What is claimed is:

1. A method for obtaining mobile metrics comprising:
obtaining at least one of a user-specific information and a mobile web data, wherein the at least one of the user specific information and the mobile web data relates to at least one of a mobile device and a user associated with the mobile device;
generating a user profile based upon the at least one of the user-specific information and the mobile web data; and
analyzing the user profile to determine mobile metrics relating to the at least one of the mobile device and the user.

2. The method of claim 1, wherein the user specific information includes information about the user from obtained from a carrier subscription record.

3. The method of claim 1, wherein the user specific information include an Internet Protocol address associated with the mobile device.

4. The method of claim 1, wherein the mobile web data includes a record of vendor information accessed by at least one of the mobile device and the user associated with the mobile device.

5. The method of claim 1, wherein the user profile includes at least one of a demographic information, a psychographic information, and a geographic information for the user associated with the mobile device.

6. The method of claim 1, wherein the step of analyzing the user profile includes displaying on a graphic display at least a portion of the user profile.

7. A method for obtaining mobile metrics comprising:
accessing a vendor information using a mobile device;
obtaining a user-specific information for a user associated with the mobile device;
obtaining a mobile web data associated with at least one of the mobile device and the user associated with the mobile device;
generating a user profile based upon at least one of the user-specific information and the mobile web data; and
analyzing the user profile to determine mobile metrics relating to the at least one of the mobile device and the user.

8. The method of claim 7, wherein the step of accessing a vendor information is executed using a gateway code to obtain information associated with a specific product or service.

9. The method of claim 7, wherein the user specific information includes at least one of a telephone numbers associated with the mobile device, the vendor information accessed by the mobile device, a name and address of the user associated with the mobile device, a geographic information about a location of the mobile device, a time the user specific information is obtained, and an internet protocol addresses associated with the mobile device.

10. The method of claim 7, wherein the mobile web data includes a record of the vendor information accessed by at least one of the mobile device and the user associated with the mobile device.

11. The method of claim 7, wherein the user profile includes at least one of a demographic information, a psychographic information, and a geographic information for the user associated with the mobile device.

12. The method of claim 7, further comprising the step of displaying on a graphic display at least a portion of the user profile, wherein the at least one of the user-specific information and the mobile web data can be obtained, updated, linked and organized, and displayed in real time.

13. The method of claim 7, further comprising the step of linking related user-specific information and mobile web data.

14. The system for obtaining mobile metrics comprising:
a server for receiving at least one of a user-specific information and a mobile web data, wherein the at least one of the user specific information and the mobile web data relates to at least one of a mobile device and a user associated with the mobile device; and
at least one processor, coupled to the server, configured for,
generating a user profile based upon the at least one of the user-specific information and the mobile web data; and
analyzing the user profile to determine mobile metrics relating to the at least one of the mobile device and the user.

15. The system of claim 14, wherein the user specific information includes information about the user from obtained from a carrier subscription record.

16. The system of claim 14, wherein the user specific information include and internet protocol address associated with the mobile device.

17. The system of claim 14, wherein the mobile web data includes a record of mobile gateway technology codes accessed by at least one of the mobile device and the user associated with the mobile device.

18. The system of claim 14, wherein the user profile includes at least one of a demographic information, a psychographic information, and a geographic information for the user associated with the mobile device.

19. The system of claim 14, further comprising a graphic display to display at least a portion of the user profile, wherein the at least one of the user-specific information and the mobile web data can be obtained, updated, linked and organized, and displayed in real time.

20. The system of claim 14, wherein the at least one of a user-specific information and a mobile web data is received by the server in response to a vendor information being accessed by the mobile device.
